(19) United States
(12) Patent Application Publication
(10) Pub. No.: US 2012/0167176 A1
(43) Pub. Date: Jun. 28, 2012

(54) METHOD AND APPARATUS FOR PAIRING BETWEEN BLUETOOTH DEVICES

(75) Inventors: Daniel Hwang, Suwon-si (KR); Dong-Han Kang, Suseong-gu (KR); Sang-Cheong Kim, Gumi-si (KR)

(73) Assignee: SAMSUNG ELECTRONICS CO., LTD., Suwon-si (KR)

(21) Appl. No.: 13/336,267

(22) Filed: Dec. 23, 2011

(30) Foreign Application Priority Data
Dec. 28, 2010 (KR) 10-2010-0136501

(51) Int. Cl. H04L 9/00

(52) U.S. Cl. 726/3

(57) ABSTRACT

A method and apparatus for pairing between Bluetooth devices, If a pairing between Bluetooth devices is requested, a six-digit passkey is generated in an authentication process based on secure simple pairing (SSP). If a Bluetooth device (BD) address of a correspondent device is pre-registered and there are characters designated to the BD address, the designated characters instead of the passkey are outputted.

### CROSS-REFERENCE TO RELATED APPLICATION AND CLAIM OF PRIORITY

This application is related to and claims priority under 35 U.S.C. §119 to an application filed in the Korean Intellectual Property Office on Dec. 28, 2010 and assigned Serial No. 10-2010-0136501, the contents of which are incorporated herein by reference.

### TECHNICAL FIELD

The present disclosure relates generally to a method and apparatus for pairing between Bluetooth devices, and in particular, to a method and apparatus for pairing between Bluetooth devices, which outputs one or more characters representing a correspondent device to be paired.

### BACKGROUND

Due to the development of electronic communication industries, portable terminals, such as mobile communication terminals (cellular phones), electronic notes, and personal digital assistants (PDA), are becoming necessities in modern society. These portable terminals are an important means for information transmission that is rapidly changing. The portable terminals provide a variety of multimedia services as well as call functions.

In these circumstances, much attention has recently been paid to Bluetooth communication technology. Bluetooth is one of a number of short-range radio communication standards and refers to a technology standard for wireless connection and control of various electronic and information communication devices within a radius of 10-100 meters. As is well known, if a wireless network using Bluetooth is established, data can be freely exchanged with all information appliances. As one example, various digital household appliances as well as information communication devices such as computers, printers, mobile phones, and PDAs, which are used at home or in office, can exchange data with one another at high speed using radio frequencies, without any physical cables.

To establish a wireless network using Bluetooth, Bluetooth devices need to be paired. The pairing is to recognize the presence of devices to be connected. FIG. 1 illustrates a conventional Secure Simple Pairing (SSP) process. Referring to FIG. 1, if a search is requested, a first Bluetooth device searches devices having Bluetooth device (BD) addresses and device names by using a known Service Discovery Profile (SDP). Then, if it is requested to pair with one device C among the searched devices, two devices exchange their public keys and random variables with each other, combine them through relevant algorithms to generate six-digit numbers (hereinafter, referred to as passkeys), and output the generated six-digit passkeys. Then, a user compares the passkeys outputted from the two devices and decides whether to pair with the correspondent device. However, it is troublesome for a user to compare the six-digit passkeys one digit at a time.

### SUMMARY

To address the above-discussed deficiencies of the prior art, it is a primary aspect of the present disclosure to solve substantially solve at least the above problems and/or disadvantages and to provide at least the advantages below. Accordingly, an aspect of the present disclosure is to provide a method and apparatus for pairing between Bluetooth devices, which outputs pre-registered characters representing a correspondent device, instead of a six-digit passkey generated in an authentication process based on SSP.

According to an aspect of the present disclosure, a method for pairing between Bluetooth devices is provided. The method includes, if a pairing between Bluetooth devices is requested, generating a six-digit passkey in an authentication process based on secure simple pairing (SSP). The method also includes, if a Bluetooth device (BD) address of a correspondent device is pre-registered and there are characters designated to the BD address, outputting the designated characters, instead of the passkey.

According to another aspect of the present disclosure, an apparatus for pairing between Bluetooth devices is provided. The apparatus includes an input unit, an output unit, a storage unit configured to store data, and a communication unit configured for Bluetooth communication. The apparatus also includes a control unit configured to control an overall operation, wherein the control unit outputs, to the output unit, characters designated to a BD address of a correspondent device, which is stored in the storage unit, instead of a six-digit passkey generated in an authentication process based on SSP with respect to the correspondent device.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other objects, features and advantages of the present disclosure will become more apparent from the following detailed description when taken in conjunction with the accompanying drawings in which:

FIG. 1 schematically illustrates a conventional SSP process;

FIG. 2 schematically illustrates a pairing between Bluetooth devices according to an embodiment of the present disclosure;

FIG. 3 is a communication flow diagram for a pairing between Bluetooth devices according to an embodiment of the present disclosure; and

FIG. 4 is a block diagram of a Bluetooth device according, to an embodiment of the present disclosure.

### DETAILED DESCRIPTION

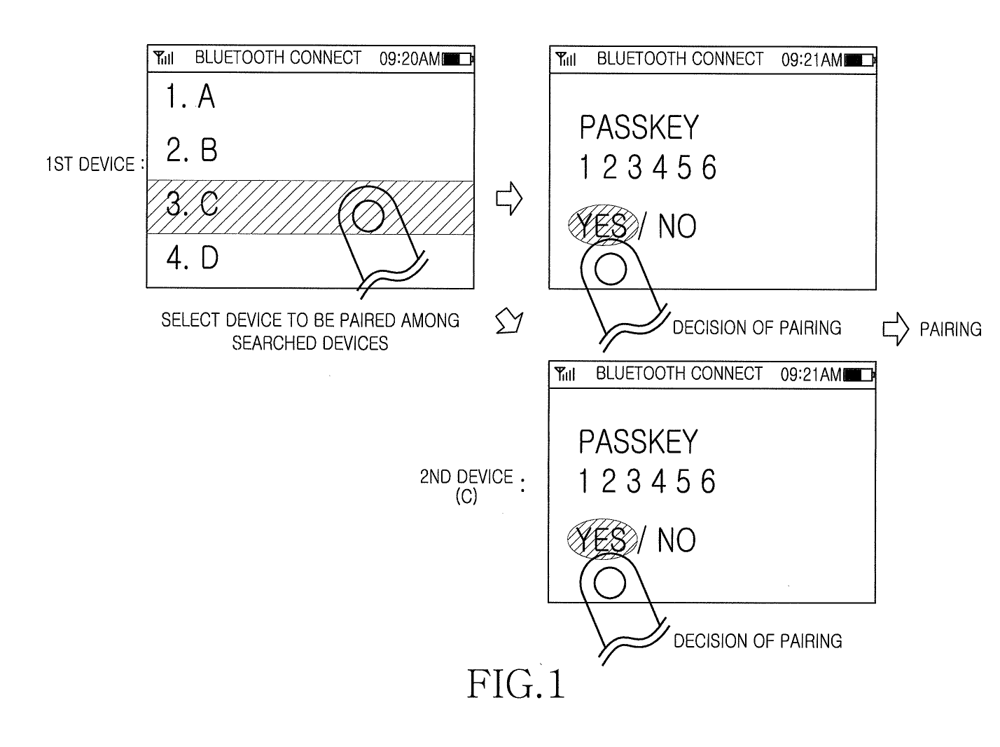

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. Preferred embodiments of the present disclosure will be described herein below with reference to the accompanying drawings. In the following description, detailed descriptions of well-known functions or configurations will be omitted since they would unnecessarily obscure the subject matters of the present disclosure. Also, the terms used herein are defined according to the functions of the present disclosure. Thus, the terms may vary depending on users' or operators' intentions or practices. Therefore, the terms used herein are to be understood based on the descriptions made herein.

The present disclosure relates to a method and apparatus for pairing, between Bluetooth devices. In particular, the present disclosure relates to a method and apparatus for outputting pre-registered characters representing a correspondent device, instead of a six (6)-digit passkey generated in an authentication process based on SSP. In general, Bluetooth devices to be paired generate six-digit passkeys through an SSP process and output the generated six-digit passkeys. Then, a user confirms the outputted passkey and decides whether to pair with the correspondent device. However, according to the embodiment of the present disclosure, if a BD address of a correspondent device is pre-registered and there are characters designated to the BD address, the designated characters instead of the passkey are outputted. (While the passkey is generally disclosed in this disclosure as a six-digit passkey, it will be understood that a passkey of any length and having any combination of numbers and characters is still within the spirit and scope of this disclosure.)

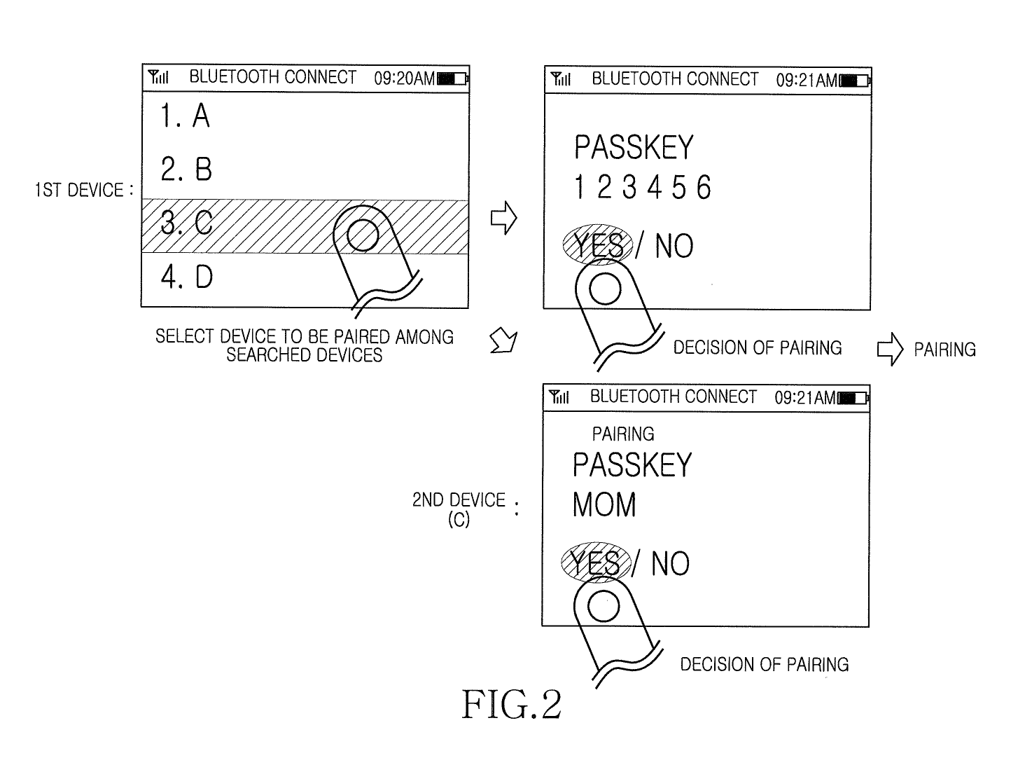

FIG. 2 schematically illustrates a pairing between Bluetooth devices according to an embodiment of the present disclosure.

Referring to FIG. 2, a first Bluetooth device searches peripheral devices to be paired. In general, the first Bluetooth device searches the peripheral devices using a known SDP. The first Bluetooth device and the peripheral devices exchange BD addresses (for example, 00:11:22:33:44:55) and device names. As one example, as illustrated in FIG. 2, the first Bluetooth device searches devices whose device names are ‘A’, ‘B’, ‘C’ and ‘D’. The device names may be product identification numbers.

Thereafter, if a user selects one device ‘C’ among the searched devices, the first Bluetooth device and the second Bluetooth device ‘C’ generate six-digit passkeys based on SSP. However, if the BD address of the first Bluetooth device is pre-registered in the second Bluetooth device and there are representative characters designated to the BD address, the second Bluetooth device outputs the representative characters, instead of the passkey. As illustrated in FIG. 2, the second Bluetooth device outputs the representative characters (e.g., “MOM”), instead of the passkey. The user directly inputs and stores the BD address of the correspondent device and the designated representative characters in the second Bluetooth device. Therefore, the user of the second Bluetooth device may easily confirm the presence of the correspondent device set by the user herself.

If the user decides to pair with the correspondent device, the two devices are paired.

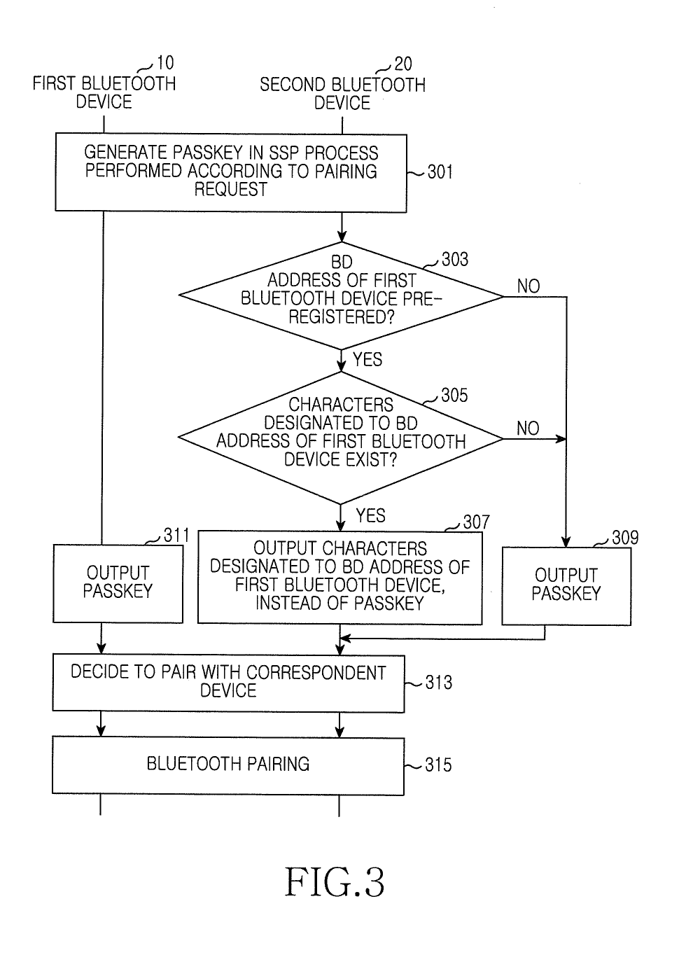

FIG. 3 is a communication flow diagram for a pairing between Bluetooth devices according to an embodiment of the present disclosure.

Referring to FIG. 3, a first Bluetooth device 10 and a second Bluetooth device 20 perform the following Bluetooth pairing procedure. If the pairing, is requested, the first Bluetooth device 10 and the second Bluetooth device 20 generate six-digit passkeys through an SSP process in block 301.

The first Bluetooth device 10 outputs the generated passkey in block 311.

In block 303, the second Bluetooth device 20 determines whether a BD address of the first Bluetooth device 10 is pre-registered therein. In block 305, the second Bluetooth device 20 determines whether there are representative characters designated to the pre-registered BD address of the first Bluetooth device 10.

In block 309, the second Bluetooth device 20 outputs the passkey if the BD address of the first Bluetooth device 10 is not pre-registered or if there are no representative characters designated to the BD address of the first Bluetooth device 10 even though the BD address of the first Bluetooth device 10 is pre-registered. In block 307, the second Bluetooth device 20 outputs the representative characters, instead of the passkey, if there are representative characters designated to the BD address of the first Bluetooth device 10.

Thereafter, if the user decides to pair with the correspondent device in block 313, the two Bluetooth devices 10 and 20 are paired in block 215.

If a BD address of the second Bluetooth device 20 is pre-registered in the first Bluetooth device 10 and there are representative characters designated to the BD address of the second Bluetooth device 20, the first Bluetooth deice 10 may also output the representative characters, instead of the passkey.

In another embodiment, if the passkey is generated, the first Bluetooth device 10 asks the second Bluetooth device 20 if the BD address of the first Bluetooth device 10 is pre-registered therein and if there are representative characters designated to the pre-registered BD address. If the first Bluetooth device 10 is notified from the second Bluetooth device 20 that there are representative characters of the first Bluetooth device 10, the first Bluetooth device 10 may output the representative characters, instead of the passkey. That is, the two Bluetooth devices 10 and 20 may output the same representative characters.

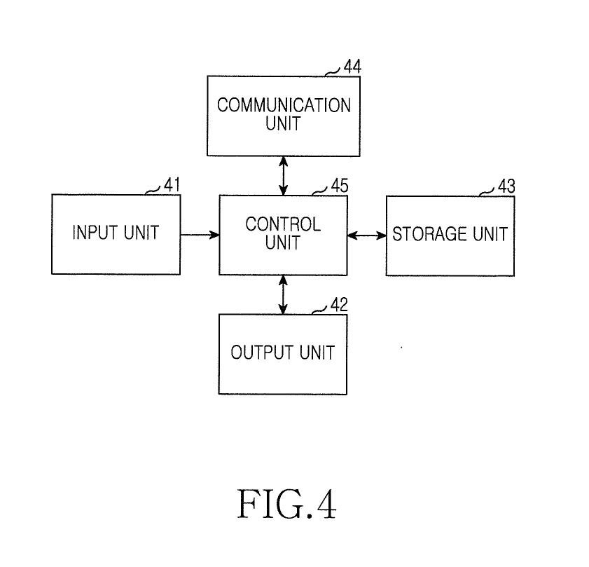

FIG. 4 is a block diagram of a Bluetooth device according to an embodiment of the present disclosure.

Referring to FIG. 4, the Bluetooth device according to the embodiment of the present disclosure includes an input unit 41, an output unit 42, a storage unit 43 for storing data, a communication unit id for Bluetooth communication, and a control unit 45 for controlling an overall operation of the Bluetooth device.

The input unit 41 outputs a signal to the control unit 45 according to a user's data input, and the output unit 42 outputs voice data or display data corresponding to an input signal under the control of the control unit 45.

The storage unit 43 stores a program for controlling the overall operation of the Bluetooth device, and a variety of data inputted/outputted during the control operation of the Bluetooth device. In particular, the storage unit 43 stores a BD address of a correspondent device and representative characters designated to the BD address.

The communication unit 44 performs a Bluetooth communication under the control of the control unit 45.

The control unit 45 controls the overall operation of the Bluetooth device. For example, the control unit 45 processes and controls voice communication and data communication. In addition to the general functions, the control unit 45 controls the output of the characters representing the correspondent device, instead of the six-digit passkey generated in the SSP process with respect to the correspondent device. As described above, the control unit 45 performs the above operation when the BD address of the correspondent device is pre-registered in the storage unit 43 and there are characters designated to the pre-registered BD address. However, the control unit 45 outputs the passkey when the BD address of the correspondent device is not pre-registered in the storage unit 43, or when there are no characters designated to the BD address of the correspondent device even though the BD address of the correspondent device is pre-registered.

Consequently, the method and apparatus for pairing between the Bluetooth devices according to the exemplary embodiments of the present disclosure allow a user to easily decide the Bluetooth pairing because the pre-registered characters representing the correspondent device are outputted, instead of the six-digit passkey generated in the authentication process based on the SSP.

While the disclosure has been shown and described with reference to certain preferred embodiments thereof, it will be understood by those skilled in the art that various changes in form and details may be made therein without departing from the spirit and scope of the disclosure as defined by the appended claims. Therefore, the scope of the disclosure is defined not by the detailed description of the disclosure but by the appended claims, and all differences within the scope will be construed as being included in the present disclosure.

What is claimed is:

1. A method for pairing between Bluetooth devices, comprising:
if a pairing between Bluetooth devices is requested, generating a passkey in an authentication process based on secure simple pairing (SSP); and
if a Bluetooth device (BD) address of a correspondent device is pre-registered and there are characters designated to the BD address, outputting the designated characters, instead of the passkey.

2. The method of claim 1, further comprising outputting the passkey if the BD address of the correspondent device is not pre-registered.

3. The method of claim 1, further comprising outputting the passkey if there are no characters designated to the BD address even though the BD address of the correspondent device is pre-registered.

4. The method of claim 1, wherein the passkey is a six-digit passkey.

5. The method of claim 1, further comprising receiving an indication from a user to pair the Bluetooth devices.

6. The method of claim 5, further comprising pairing the Bluetooth devices.

7. The method of claim 1, wherein at least one of the Bluetooth devices is a mobile communication terminal.

8. An apparatus for pairing between Bluetooth devices, comprising:
an input unit;
an output unit;
a storage unit configured to store data;
a communication unit configured for Bluetooth communication; and
a control unit configured to control an overall operation,
wherein the control unit outputs, to the output unit, characters designated to a BD address of a correspondent device, which is stored in the storage unit, instead of a passkey generated in an authentication process based on secure simple pairing (SSP) with respect to the correspondent device.

9. The apparatus of claim 8, wherein the control unit outputs the passkey to the output unit if the BD address of the correspondent device is not pre-registered in the storage unit.

10. The apparatus of claim 8, wherein the control unit outputs the passkey to the output unit if there are no characters designated to the BD address even though the BD address of the correspondent device is pre-registered.

11. The apparatus of claim 8, wherein the passkey is a six-digit passkey.

12. The apparatus of claim 8, wherein the apparatus receives an indication from a user to pair the Bluetooth devices

13. The apparatus of claim 12, wherein the apparatus is configured to pair the Bluetooth devices upon receiving the indication from the user.

14. The apparatus of claim 8, wherein the apparatus is a mobile terminal.

15. An system for pairing Bluetooth devices, comprising:
a first Bluetooth device; and
a second Bluetooth device;
wherein the first Bluetooth device comprises:
a display unit;
a storage unit configured to store data;
a communication unit configured for Bluetooth communication; and
a control unit configured to control an overall operation,
wherein the control unit outputs, to the display unit, characters designated to a BD address of a correspondent device, which is stored in the storage unit, instead of a passkey generated in an authentication process based on secure simple pairing (SSP) with respect to the second Bluetooth device.

16. The system of claim 15, wherein the control unit outputs the passkey to the display unit if the BD address of the second Bluetooth device is not pre-registered in the storage unit.

17. The system of claim 15, wherein the control unit outputs the passkey to the display unit if there are no characters designated to the BD address even though the BD address of the second Bluetooth device is pre-registered.

18. The system of claim 15, wherein the passkey is a six-digit passkey.

19. The system of claim 15, wherein the system receives an indication from a user to pair the Bluetooth devices

20. The system of claim 19, wherein the system is configured to pair the Bluetooth devices upon receiving the indication from the user.
